(19) United States
(12) Patent Application Publication
(10) Pub. No.: US 2011/0011352 A1
(43) Pub. Date: Jan. 20, 2011

(54) LEASH ASSEMBLY FOR A PET

(76) Inventor: Hsiu-Hsia Lee, Yunlin County (TW)

Correspondence Address: HOLLAND & HART, LLP, P.O BOX 8749, DENVER, CO, 80201, US

(21) Appl. No.: 12/505,856

(22) Filed: Jul. 20, 2009

(51) Int. Cl. A01K 27/00

(52) U.S. Cl. 119/797; 119/798

(57) ABSTRACT

A leash assembly for a pet includes a leash unit and first and second clips. The leash unit includes a handle portion, a straight portion, and a coiled portion. The handle portion is formed into a loop. The straight portion is straight in shape, and is connected to the handle portion. The coiled portion is helical in shape and is connected to the handle portion. Each of the first and second clips is provided on a respective one of the straight portion and the coiled portion of the leash unit.

### BACKGROUND OF THE INVENTION

1. Field of the Invention

This invention relates to a leash assembly, more particularly to a leash assembly for a pet.

2. Description of the Related Art

A conventional leash has an end that is provided with a clip, and another end that is formed into a loop and that serves as a handle. When an owner wishes to walk a pet, such as a dog, the conventional leash is attached to a collar of the dog via the clip.

The aforementioned conventional leash is disadvantageous in that while walking the dog, when the conventional leash sags, part of the conventional leash may be dragged on the ground. This can wear and dirty the conventional leash and may get the conventional leash entangled around the legs of the dog and the owner. The owner usually applies a pulling force on the conventional leash in order to prevent sagging thereof. However, this pulling force on the conventional leash may strain the neck of the dog. To solve the aforementioned problems, it has been proposed to use a retractable leash that is capable of winding or unwinding a leash to thereby adjust the length thereof. The conventional retractable leash, however, has a complex structure, is easily damaged, and includes a spring which losses its tension over a period of time.

### SUMMARY OF THE INVENTION

Therefore, an object of the present invention is to provide a leash assembly for a pet that can overcome the aforesaid drawbacks of the prior art.

According to the present invention, a leash assembly for a pet comprises a leash unit and first and second clips. The leash unit includes a handle portion, a straight portion, and a coiled portion. The handle portion is formed into a loop and has opposite ends. The straight portion is straight in shape, and has a first end connected to one of the opposite ends of the handle portion, and a second end opposite to the first end thereof. The coiled portion is helical in shape, and has a first end connected to the other of the opposite ends of the handle portion, and a second end opposite to the first end thereof. Each of the first and second clips is provided on the second end of a respective one of the straight portion and the coiled portion of the leash unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a leash assembly according to this invention;

FIG. 2 is a schematic sectional view illustrating a fastening member of the preferred embodiment; and

FIGS. 3 and 4 are perspective views illustrating the preferred embodiment in a state of use.

### DETAILED DESCRIPTION OF THE PREFERRED EMBODIMENT

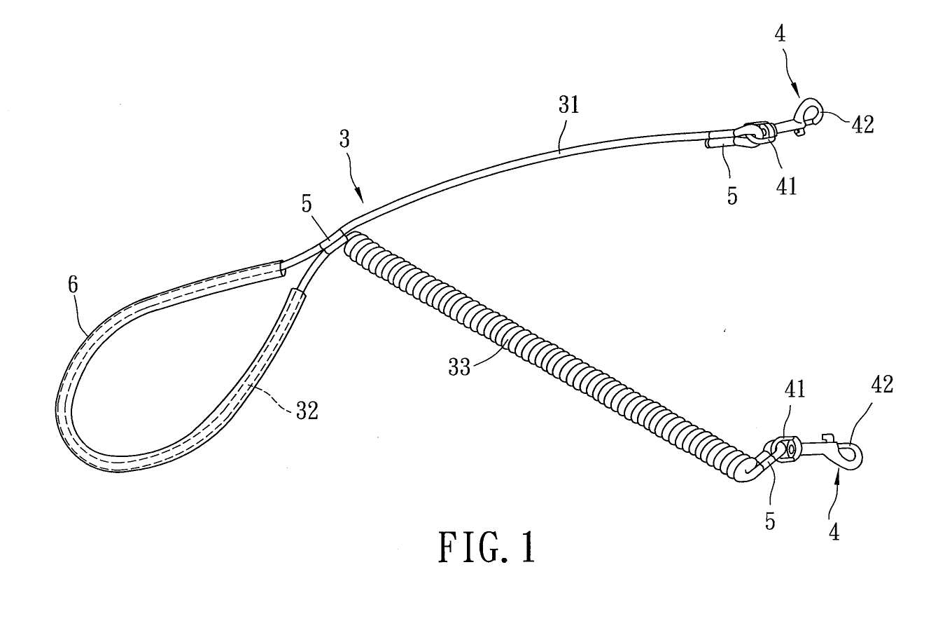

Referring to FIG. 1, the preferred embodiment of a leash assembly according to this invention is shown to include a leash unit 3 and first and second clips 4.

The leash assembly of this invention is applicable for a pet 2, such as a dog.

The leash unit 3 has a handle portion 32, a straight portion 31, and a coiled portion 33.

The handle portion 32 of the leash unit 3 is formed into a loop, serves as a handle, and has opposite ends.

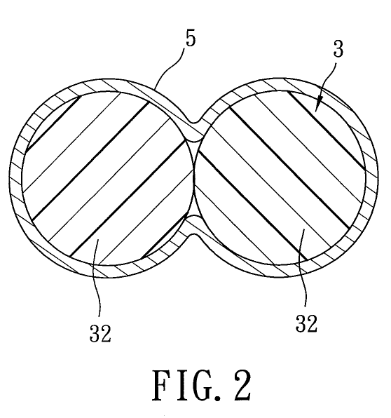

With further reference to FIG. 2, the leash assembly further includes a first fastening member 5 that is tubular, that is sleeved on the opposite ends of the handle portion 32 of the leash unit 3, and that is deformed to thereby interconnect the opposite ends of the handle portion 32 of the leash unit 3.

The straight portion 31 of the leash unit 3 is generally straight in shape, and has a first end connected to one of the opposite ends of the handle portion 32 of the leash unit 3, and a second end opposite to the first end thereof.

The coiled portion 33 of the leash unit 3 is helical in shape, which is similar to that of a coiled spring, and has a first end connected to the other of the opposite ends of the handle portion 32 of the leash unit 3, and a second end opposite to the first end thereof.

Each of the first and second clips 4 includes a loop portion 41, and a hook portion 42 connected to the loop portion 41 thereof. Since the first and second clips 4 are known in the art, and since the feature of the invention does not reside in the particular configuration of the same, a detailed description thereof will not be provided herein for the sake of brevity.

The first clip 4 is provided on the second end of the straight portion 31 of the leash unit 3. In particular, the second end of the straight portion 31 of the leash unit 3 passes through the loop portion 41 of the first clip 4. The leash assembly further includes a second fastening member 5 that serves to form the second end of the straight portion 31 of the leash unit 3 into a loop.

The second clip 4 is provided on the second end of the coiled portion 33 of the leash unit 3. In particular, the second end of the coiled portion 33 of the leash unit 3 passes through the loop portion 41 of the second clip 4. The leash assembly further includes a third fastening member 5 that serves to form the second end of the coiled portion 33 of the leash unit 3 into a loop.

In this embodiment, the leash unit 3 is in the form of a single piece. As such, the leash unit 3 of the leash assembly of this invention is relatively durable. Moreover, in this embodiment, the leash unit 3 is made from a plastic material. Further, in this embodiment, each of the first, second, and third fastening members 5 is made from metal.

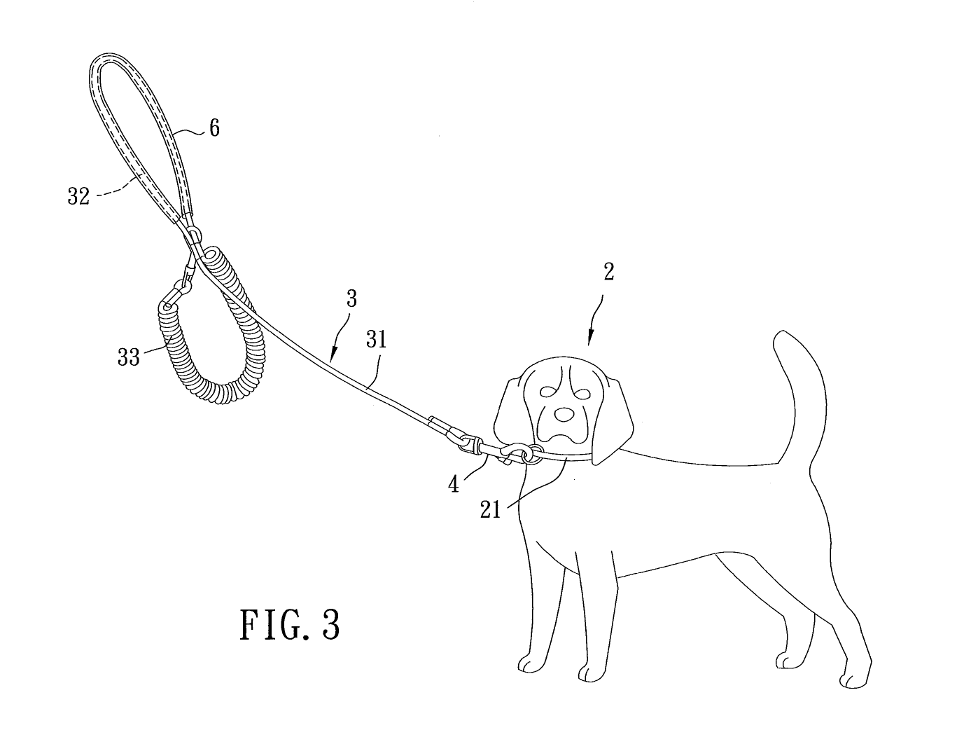

In use, as best shown in FIG. 3, when it is desired to walk the dog 2 and to keep the dog 2 close to the owner, the straight portion 31 of the leash unit 3 is attached to a collar 21, or a harness (not shown), of the dog 2 via the first clip 4. At this time, the coiled portion 33 of the leash unit 3 may be attached to the handle portion 32 of the leash unit 3 to thereby prevent the coiled portion 33 of the leash unit 3 from being drag on the ground while walking the dog 2.

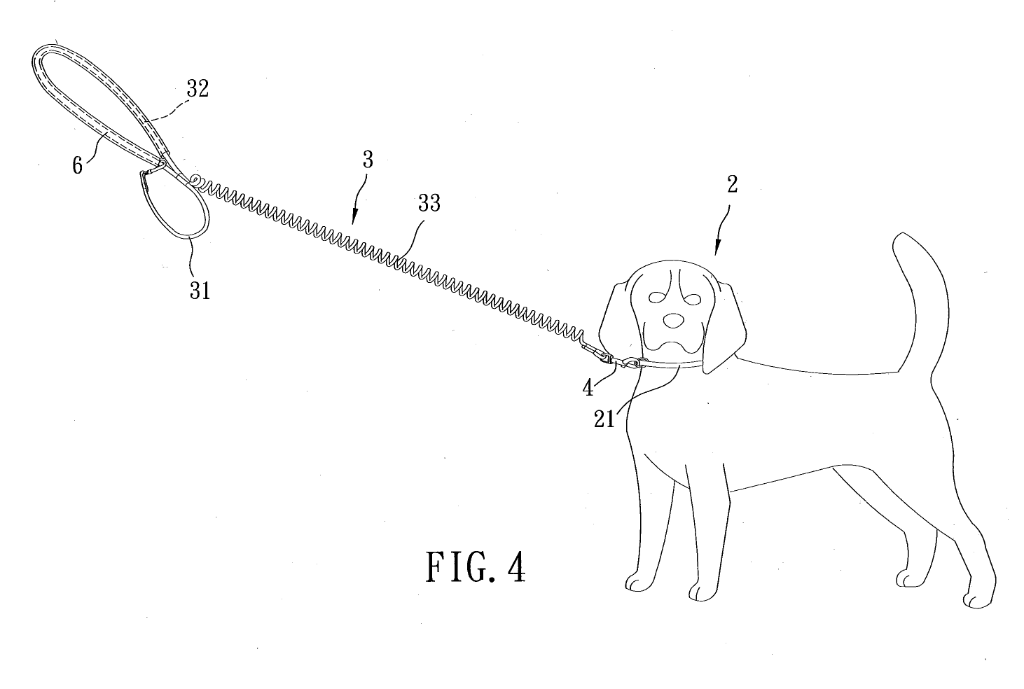

Alternatively, as best shown in FIG. 4, when it is desired to walk the dog 2 and to give the dog 2 a certain degree of mobility, the coiled portion 33 of the leash unit 3 is attached to the collar 21 of the dog 2 via the second clip 4. At this time, the straight portion 31 of the leash unit 3 may be attached to the handle portion 32 of the leash unit 3 to thereby prevent the straight portion 31 of the leash unit 3 from being drag on the ground while walking the dog 2.

It is noted that when the coiled portion 33 of the leash unit 3 is attached to the collar 21 of the dog 2, the coiled portion 33 of the leash unit 3 stretches up to five times of the relaxed length thereof when the dog 2 moves away from the owner, and returns to the original shape thereof when the dog 2 moves toward the owner. As such, the coiled portion 33 of the leash unit 3 is prevented from sagging.

The leash assembly further includes a tubular handgrip 6 sleeved on the handle portion 32 of the leash unit 3 for facilitating grasping of the handle portion 32 of the leash unit 3 by the owner. In this embodiment, the handgrip 6 is made from a material that is soft and that has a high coefficient of friction, thereby enhancing comfort for the owner, giving the owner a greater control, and preventing slipping thereof from the hand of the owner.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A leash assembly for a pet, comprising:
a leash unit including
a handle portion that is formed into a loop and that has opposite ends,
a straight portion that is generally straight in shape, and that has a first end connected to one of said opposite ends of said handle portion, and a second end opposite to said first end thereof, and
a coiled portion that is helical in shape, and that has a first end connected to the other of said opposite ends of said handle portion, and a second end opposite to said first end thereof; and
first and second clips, each of which is provided on said second end of a respective one of said straight portion and said coiled portion of said leash unit.

2. The leash assembly as claimed in claim 1, wherein said leash unit is in the form of a single piece.

3. The leash assembly as claimed in claim 1, further comprising a fastening member that interconnects said opposite ends of said handle portion of said leash unit.

4. The leash assembly as claimed in claim 1, further comprising a tubular handgrip sleeved on said handle portion of said leash unit.

5. The leash assembly as claimed in claim 1, wherein said second end of said straight portion of said leash unit passes through said first clip, said leash assembly further comprising a fastening member for forming said second end of said straight portion of said leash unit into a loop.

6. The leash assembly as claimed in claim 1, wherein said second end of said coiled portion of said leash unit passes through said second clip, said leash assembly further comprising a fastening member for forming said second end of said coiled portion of said leash unit into a loop.
